(19) United States
(12) Patent Application Publication
(10) Pub. No.: US 2008/0018453 A1
(43) Pub. Date: Jan. 24, 2008

(54) Internet homepage alert network system

(76) Inventor: Robert M. Adler, West Palm Beach, FL (US)

Correspondence Address: MCHALE & SLAVIN, P.A., 2855 PGA BLVD, PALM BEACH GARDENS, FL, 33410, US

(21) Appl. No.: 11/782,985

(22) Filed: Jul. 25, 2007

Related U.S. Application Data
(63) Continuation-in-part of application No. 11/559,318, filed on Nov. 13, 2006.
Application No. 11/559,318 is a continuation-in-part of application No. 11/414,899, filed on May 1, 2006.
Application No. 11/414,899 is a continuation-in-part of application No. 11/373,517, filed on Mar. 10, 2006.
Application No. 11/373,517 is a continuation-in-part of application No. 11/138,669, filed on May 25, 2005.

(51) Int. Cl. G08B 1/00

(52) U.S. Cl. 340/531

(57) ABSTRACT

A method of broadcasting advisory alerts via communications networks where a central notification computer is provided which operable to broadcast advisory alerts to electronic device addresses stored in a subscriber database in a computer retrievable format, namely an individual homepage. The subscriber database contains subscriber data sets which each include the electronic device address and at least one geographic location associated with the electronic device address. When an advisory alert is initiated, the affected geographic area is determined, and a geographic area defined by a perimeter is associated with the advisory alert. The alert is received on a smart alert home page which has been customized by the user based upon their personal preferences. The homepage includes advertisements which financially support the network operation. The advertisements are targeted at the user, based upon demographic profiles which they have inputted as their individual preferences.

### RELATED APPLICATIONS

This application is a continuation-in-part of U.S. patent application Ser. No. 11/559,318 filed Nov. 13, 2006, which is a CIP of 11/414,899 filed May 1, 2006 which is a CIP of U.S. patent application Ser. No. 11/373,517 filed Mar. 10, 2006 which is a CIP of U.S. patent application Ser. No. 11/138,669 filed May 25, 2005, the contents of which are herein incorporated by reference.

### FIELD OF THE INVENTION

The invention relates to communication systems, and in particular to a system for broadcasting advisory alerts, on a subscriber basis, information regarding product recalls, neighborhood crime alerts, alerts for missing persons and pets, drug and food recalls, notification regarding school emergencies and natural and manmade disasters and any other type of emergency that requires immediate notification to an individual's homepage, accessible by the internet.

### BACKGROUND OF THE INVENTION

There has been a long recognized need to provide a means for a unilateral emergency communications broadcast to the general public. In recent years, concerns about terrorist activities have only heightened the awareness that an efficient, far reaching public communication system is vital to public safety. However, the need for emergency contact for lost children and pets or the need to alert particular persons in the public regarding food or toy recalls has been an ongoing concern.

To address this need, there have been several systems implemented by the U.S. government. President Truman established the CONELRAD [CONtrol of ELectronic RADiation] system in 1951 to provide emergency alerts to the public. Under this first national alerting system, in the event of a nuclear attack on the United States, all commercial radio stations would cease normal operation in order to prevent Soviet bombers from homing in on their targets by using specific commercial radio stations as navigation beacons.

Due to criticism that it was unreliable, less than responsive to local requirements and because it relied on a “daisy-chain” of stations, the EBS was replaced by the Emergency Alerting System (EAS) in January 1997. The EAS is a digital system which ended the need to rely on intermediate stations. The major difference between the EAS and EBS systems was the method employed to alert equipment at broadcast stations about an incoming alert message. EBS used a two-tone audio signal transmitted to activate an EBS receiver. In contrast, EAS sends an information-bearing signal on a broadcast stations main audio channel. The EAS does not require intervention by broadcast station personnel.

To reach the general public, the EAS broadcasts on TV stations, television cable networks, and AM and FM radio stations. Of course, not every individual is tuned into radio or television broadcasts at a given time, and in the event of an emergency, a significant number of people will not receive the EAS broadcast.

While the entire public may not be listening to commercial broadcasts at the time of an emergency, a majority of the public is reachable via some sort of electronic communication device. At a given time, most people have access to some sort of communication device such as land based telephones, cellular telephones, pagers, personal computers having Internet connections, fax machines, etc. The pervasiveness of personal electronic communication devices has a potential, unique in technological history, for widespread emergency communication. It would therefore be highly advantageous to provide a means to simultaneously broadcast an advisory alert to such communication devices in order to reach a majority of the public in an emergency situation. In particular, the use of an internet homepage appears to be the most advantageous method of communicating as a computer intelligent community relies more on the internet as the preferred method of communication.

### DESCRIPTION OF THE PRIOR ART

The present invention is directed to a method of broadcasting geographically specific advisory alerts to personal electronic devices by utilizing an algorithm which targets recipients only in the affected geographic area. U.S. Pat. Nos. 6,505,203, 6,401,095, and 6,581,073, issued to the present inventor, are directed to systems which use an algorithm to send geographically targeted email. The contents of these patents are herein incorporated by reference. These patents are directed to systems which utilize the Internet to provide missing person or pet loss notification. The systems canvass a specific geographic area in a matter of seconds to aid in the location of a missing person or lost pet. The systems utilize an on-line enrollment form to distribute a photo email of the lost person or pet via email. Upon notification of a missing person or lost pet, the system initiates calculations, based upon the last known locations of the person or pet, to determine the most appropriate area for the search.

U.S. Pat. No. 6,023,223, to Baxter, is directed to an early warning detection and notification network for, monitoring environmental conditions comprising a plurality of remotely located environmental sensors having a communications uplink to one or more earth orbiting satellites or other forms of wireless transmission and a down link interface to a database server having a one or more data tables. End users access the system through the internet and receive real time data on environmental conditions. End users can also employ preset trigger levels for certain environmental conditions. When the trigger levels are exceeded, the end user is notified by e-mail, pager, automated voice response or the like.

These prior art patents disclose methods for sending notification email to recipients based on their geographic location as determined by an algorithm. The prior art also describes an internet accessible system for retrieving, storing and displaying real time environmental data. It would be highly desirable to utilize an enriched alert system in order to provide a multi media alert which is capable of rapidly delivering vital emergency information to end users within a defined geographical area.

### SUMMARY OF THE INVENTION

It is an objective of the instant invention to provide a subscriber-based advisory alert broadcast system which receives advisory alerts in a medium that a modern person views on a consistent basis, namely a homepage.

It is another object of the invention to provide a subscriber-based advisory alert system which utilizes video, voice, pictures and text to transmit a multi-media alert to the user and their loved ones warning of emergency situations in their area.

It is another objective to provide a subscriber-based advisory alert broadcast system which maintains a subscriber database in which the homepage is associated with at least one geographic location.

It is still another objective to provide a subscriber-based advisory alert broadcast system which associates a geographic area with a given advisory alert, and utilizes an algorithm to deliver alerts only to homepages associated with the geographic area.

It is still another objective to provide a subscriber-based advisory alert broadcast system that enables the end to users to customize a smart user page. The user page allows you to keep in touch with the people you care about and see the news and information that you want to see. In addition it is easily set up with the user's preferences.

It is still another objective to provide a subscriber-based advisory alert broadcast system which provides central monitoring station which can receive event reports from individual subscribers, thus providing a localized on-line neighborhood crime watch service. In addition, this feature can be used by schools to notify parents of school emergencies which might result in lock downs, evacuations (to a secure holding center) or early dismissals.

It is yet another objective to provide a subscriber-based advisory alert broadcast system which does not require any modification to the end user equipment or software.

It is a further objective of the invention to provide a communications interface for personal electronic devices such as computers, telephones, cellular phones, pagers, PDA devices, and fax machines in order to create a unilateral emergency communications system.

In light of the above, the applicant proposes a method of broadcasting advisory alerts in sound and/or video and/or text format to personal electronic devices on a subscriber basis via the Internet. The advisory alerts originate from a central notification computer; each personal electronic device has an address (an email address or a telephone number) which is associated with at least one geographic location in a subscriber database located on the central notification computer. When an advisory alert is initiated, the event triggering the advisory alert is associated with a geographic area having a defined perimeter, the geographic area typically being that which would be affected by the event. An algorithm retrieves the addresses of the electronic devices which are associated with geographic locations located within the perimeter. The advisory alert is then sent only to the retrieved addresses, namely the addresses of individual homepages. Thus, the invention can function as an on-line neighborhood crime watch service by providing a central monitoring station to receive reports from individual subscribers which are then transmitted to the devices within the relevant areas.

In accordance with above objectives, a method of broadcasting advisory alerts via communications networks is as follows: a central notification computer is provided which is operable to broadcast advisory alerts to electronic device addresses stored in a subscriber database in a computer retrievable format. The subscriber database contains subscriber data sets which each include the electronic device address and at least one geographic location associated with the electronic device address. When an advisory alert is initiated, the affected geographic area is determined, and a geographic area defined by a perimeter is associated with the advisory alert. An algorithm is activated to retrieve addresses of the electronic devices associated with geographical locations within the perimeter. The advisory alert is then transmitted to the electronic device addresses associated with geographic locations within the perimeter.

In one embodiment of the invention, the communications network is a computer network, such as the Internet, and the electronic device addresses are e-mail addresses. The advisory alerts can be in video, voice, pictures and text format, or any combination thereof, and transmitted to the electronic devices via an automated e-mail distribution module executable at the notification computer.

The invention can further include the step of providing an advertising module executable at the notification computer which is configured to select advertisement content from a database of advertisers located within the geographical location associated with the advisory alert. The advisory alert is thus configured to provide the advertisement in conjunction with the advisory alert so as to pass the cost of operation to advertisers.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a flow diagram of the smart alert network software integration

FIGS. 2A & 2B is an online screen shot of the smart alert customized home page.

FIGS. 3A & 3B is an online screen shot of the smart alert user's sign up page.

FIG. 4 is an online screen shot for the identification of sexual offenders in the neighborhood.

FIG. 5 is a user's contact page

FIGS. 6A & 6B is an online screen shot depicting various advisory alerts.

### DETAILED DESCRIPTION OF THE INVENTION

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

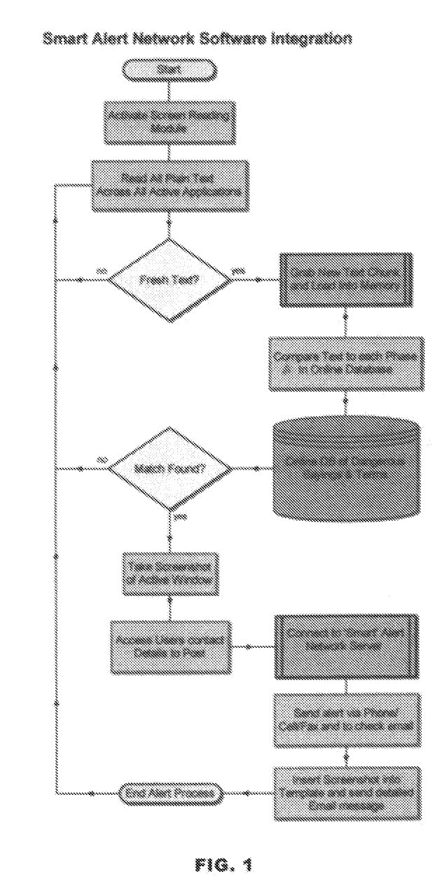

FIG. 1 is a flow diagram of one embodiment of the smart alert network software integration. In this embodiment, a screen reading module is activated wherein all plain text is read to determine if any changes to the text has occurred. If a change has occurred, the new text is loaded into memory and compared to text stored in an online database, the online database used in this embodiment being directed to dangerous sayings and terms. If a match is found to the database of dangerous sayings and terms, a screenshot is taken of the active window and the system is connected to a network server. Notification is sent via phone, cell/fax, and e-mail. In particular, the notification appears on the individual's homepage as an alert that their child may be exposed to this text.

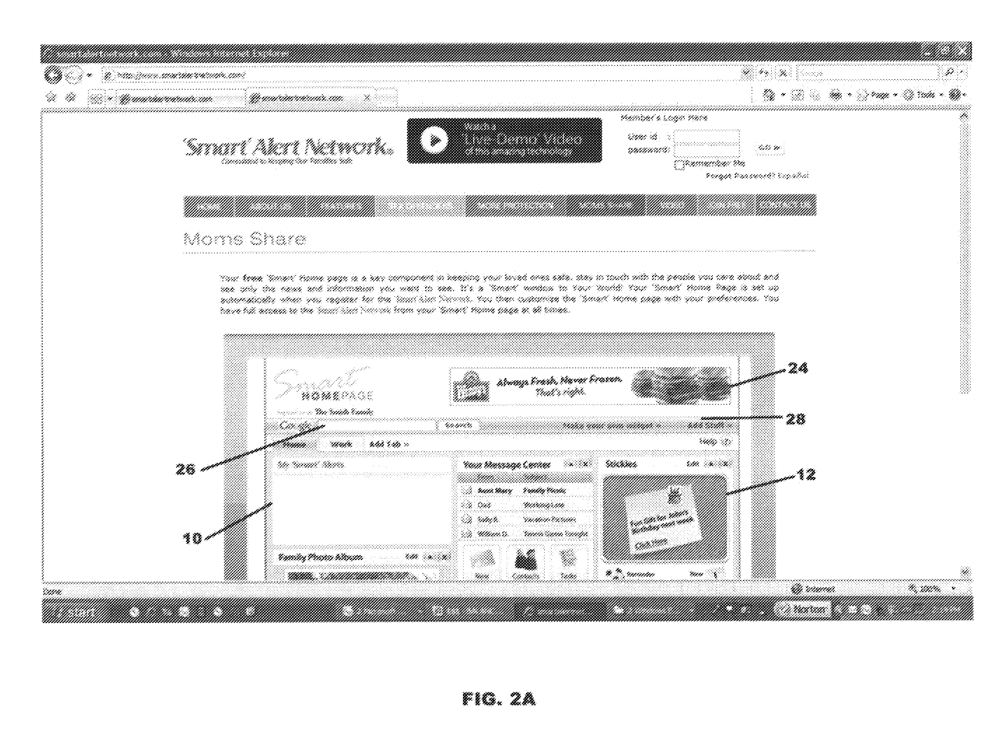

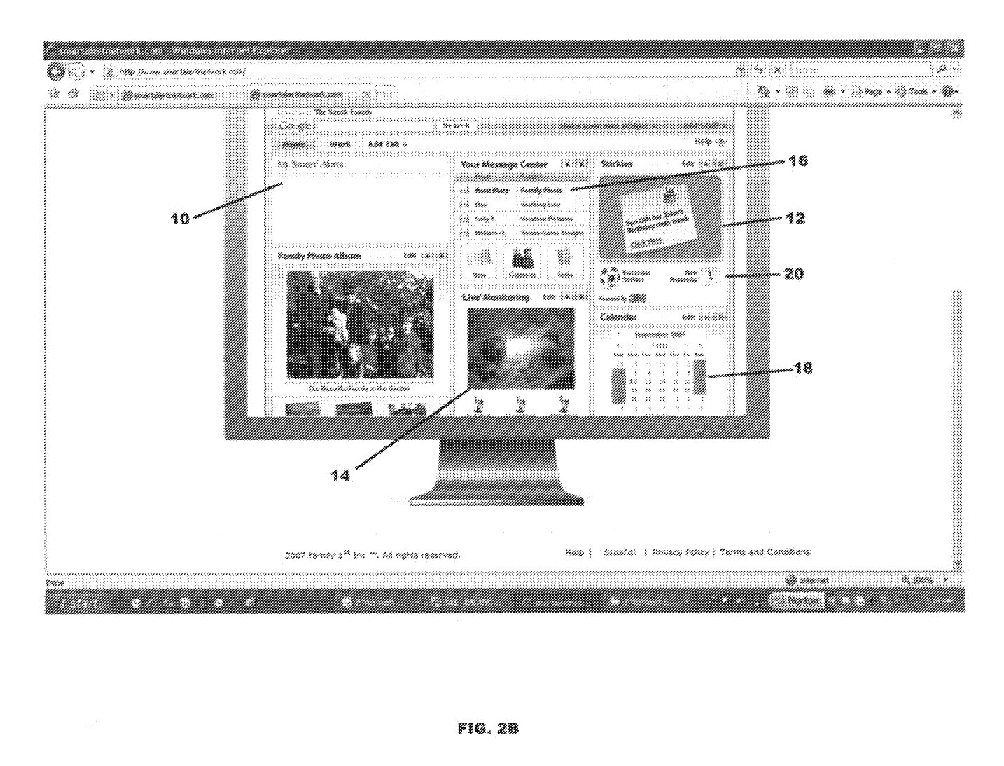

FIGS. 2A & 2B is an online screen shot of the smart alert customized home page. The customized home page includes various windows that are user selected and custom configured to the user's preferences. As shown in FIG. 2 the home page includes a section 10 dedicated to “My Smart Alerts”. This section can be populated with various alerts pre designated by the user's preferences. It could include for example, sexual predator alerts, food and drug alerts, product recall alerts (such as for toys for example), natural or man made disasters notifications, school emergency notifications, etc. Another window could include a message center 16 which would display an inbox of e-mail messages. Still another window could include live video monitoring 14 such as an infant's crib. Still another window could contain a message board 20 of pending activities, a “to do” list or another other time of reminder notification. Still another window could contain a message board of virtual sticky notes 12 of pending activities, containing a “to do” list or other type of reminder notification. Yet another window could include a calendar 18 and event scheduling screen. The top portion 24 of the home smart page would be dedicated to paid advertising. This would be targeted advertising based upon the demographics compiled from the user's preferences screen. There would also be a Google® search link 26 near the header portion of the screen. In addition the user would have the capability to make their own widgets to bring other data fields 28 into the smart home page.

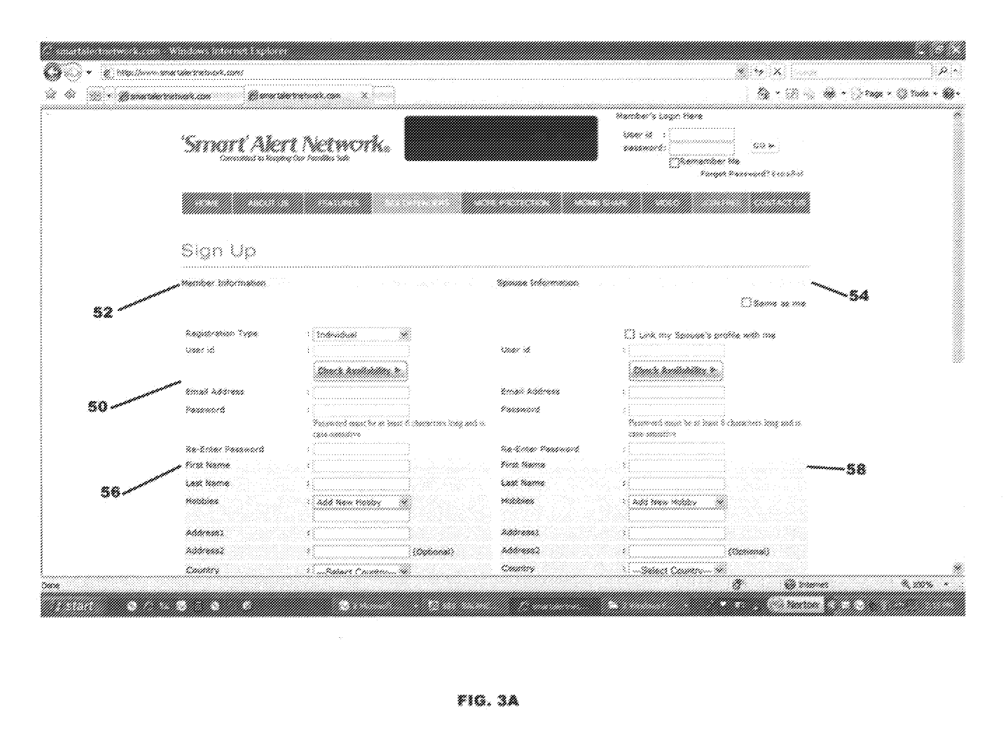

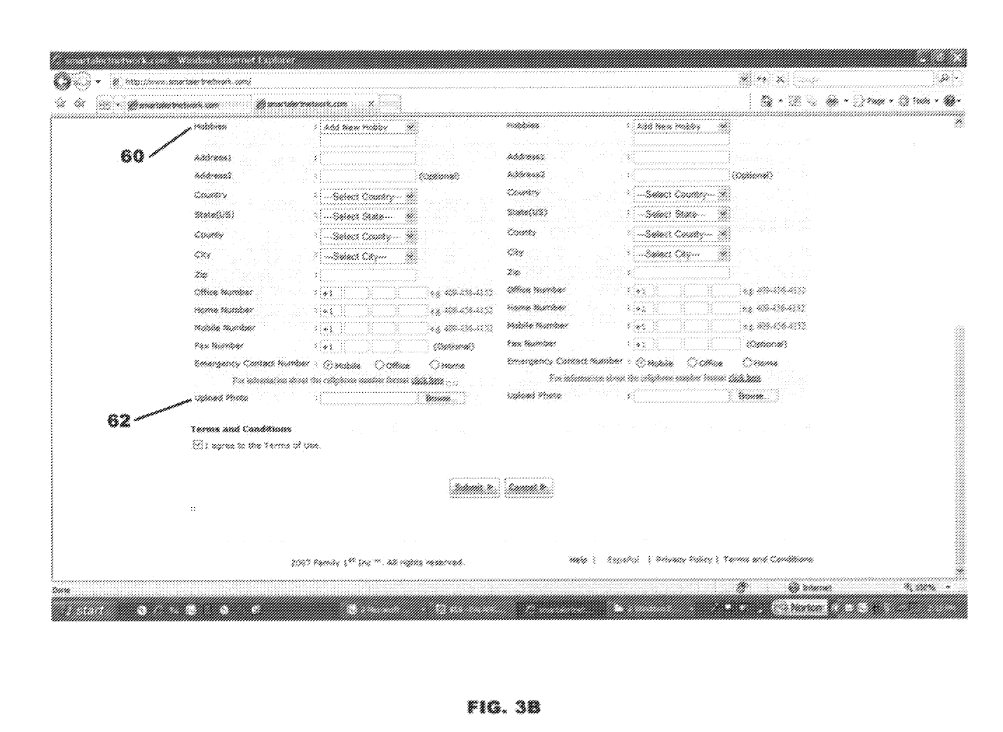

FIGS. 3A & 3B is an online screen shot of the smart alert user's sign up page 50. It includes data input fields for both the user 52 and a spouse 54. The data fields 56 & 58 include an address, and telephone numbers for home, office, mobile and fax and emergencies. It also permits the user and spouse to end their hobbies 60 and an upload of photos 62. This page has multi lingual capabilities.

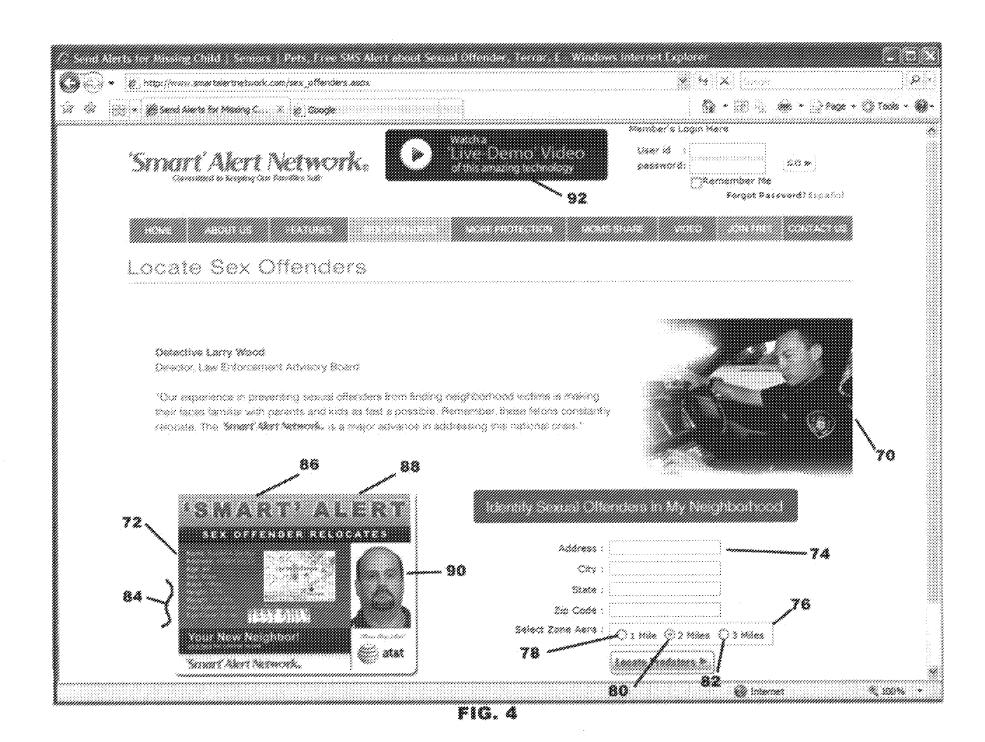

FIG. 4 is an online screen shot 70 of a page designed to identify sexual offenders 72 in the neighborhood. The user inputs 74 their address, city, state and zip code as well as the zone area 76 the user desires to cover, be it one 78, two 80 or three 82 miles. The Offender Alert page then produces an identification card like image of the offender(s) which contain a textural description 88 of the individual, a map 88 identifying his/her location, and a photograph 90. A sponsor's message, icon or logo will appear of this identification card like image to help financially support the smart alert network 92.

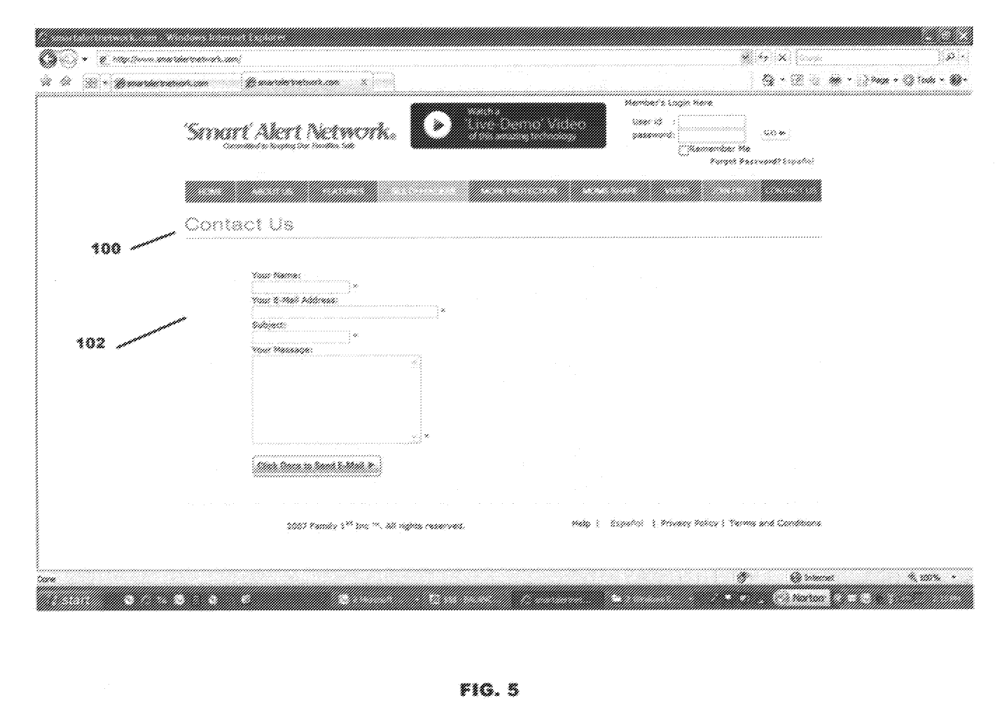

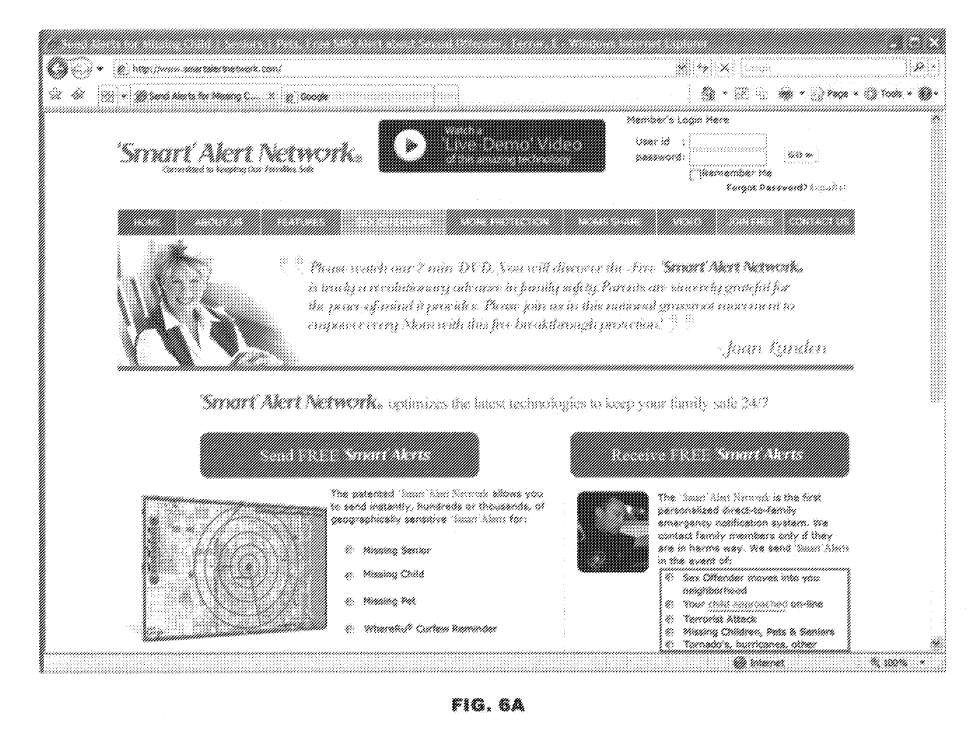

FIG. 5 is a user's contact page 100 wherein the user can provide direct input 102 to the network support staff to input and disseminate the critical information.

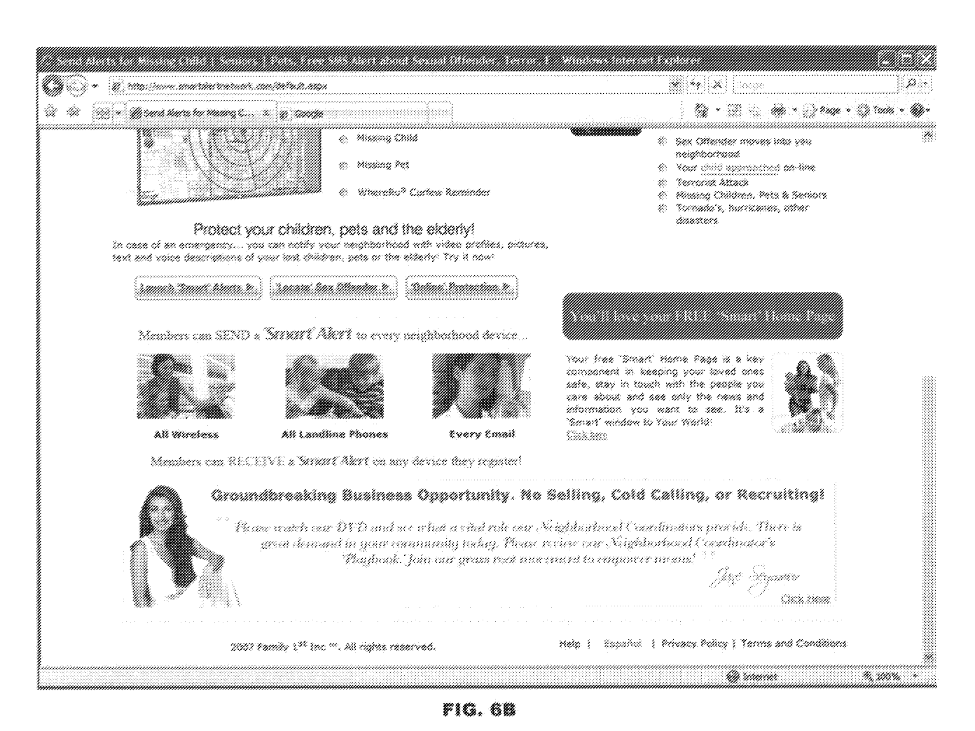

FIG. 6 is a screen shot of a video alert message 110 concerning a missing child. The utilization of video, voice, pictures and text turns every home and office phone, cell phone, every home and office computer and every wireless device into a multi-media alert system. The utilization of streaming video in lieu of text or even a still photo is a significant improvement when searching for a loved one or a missing pet. The multimedia will provide insight into the body language, personality, voice, accents, speech patterns, facial expressions and so forth thereby greatly enhancing a person's ability to recognize a lost child, senior or pet. If a child, senior or anyone for that matter, should become lost, missing or abducted the family member will call 911 and then the alert network. The network will then instantly send out a missing alert message to all neighborhood members and businesses in the immediate area. The person's picture and vital statistics will appear on all member's cell phones, land lines computers and wireless devices in the critical area. When available, video clips will also be transmitted to those electronic devices that are enabled to receive these signals. In the event the child or person is not located within the first hour the geographical area of dissemination will be expanded automatically by software within the network system. The area of dissemination will continue to be increased as a function of time until the child or person is located. For example, if the child or person is not located in the first hour, the area for alert will be expanded from the immediate area to the entire county, then state, and then nationwide if necessary. The alert system can also be used in the recovery of one's pet. When a network member loses a pet, the pet's picture and text description are transmitted to the large member network of computers, cell phones and other wireless devices. A multi media video transmission could be used, if available. The area of dissemination is local at the outset and then expands as a function of time as in the case of missing persons.

By way of example, an advisory alert for product recalls may be formed by first polling for product recalls, as detailed in U.S. application Ser. No. 11/559,318 incorporated herein. Preferably the polling is performed automatically by use of the notification computer accessing of the global computer network on a scheduled basis by searching websites, both government and private, for notice of a product recall. Optionally the notice can be polled by contact directly, e.g. by use of a telephone wherein the information is entered manually from a source when the recall is life threatening and use of a website recall could take to long. When a polling function locates a product recall, the product recall is compared against the subscriber data base to compile a list of subscribers affected by said product-recall. The advisory alert is formulated for the product-recall by first comparing age against the subscriber database, and then the geographical area. Once a list of affected subscribers is compiled, a product recall advisory is initiated at the central notification computer. A geographic area having a defined perimeter is associated with the advisory alert which is typically the general location which may be affected by the event. An algorithm is then activated at the central notification computer to retrieve the electronic device addresses for the subscribers associated with locations within the perimeter. In this embodiment, the advisory alert is then transmitted in both text, pictorial and voice format to the subscriber addresses and displayed on the advisory.

For instance, toy chests were recalled by Delta Enterprise Corporation in November of 2006 due to red paint that contained lead. While the manufacturer is able to determine which store purchased the toys, the stores did not track the individual consumers. In such an instance, the subscriber list is compared for ages that may be affected and if they live in an area of a calculated radius to be affected. Thus, the product being recalled may be used by a nine year old in the West Palm Beach area. An advisory alert is sent to the parents of all children, ages six through twelve that reside within fifteen miles of the store that the product was purchased. Even if the parent did not purchase such a product, the parent would instruct the child not to play with a red toy at any of his friend(s) homes. Such a targeted advisory alert assures that the product target audience is located thereby eliminating over saturating of the consumer with alerts, which typically results in lack of response.

FIGS. 6A & 6B illustrates the screen display leading to the various advisory alerts for a Missing Senior, Missing Child, Missing Pet, sex offender, terrorist attack, weather, and so forth. An advertising field can be juxtaposed with the advisory alert which simultaneously delivers advertising content to the end user. To accomplish this step, an advertising module can be provided which is executable at the notification computer. The advertising module is to select advertisement content from a database of advertisers located within the geographical location associated with the advisory alert and then provide advertisement in conjunction with the advisory alert. The foregoing example was of an advisory alert in text format, however the same content can be sent in the form of a sound recording to telephone subscribers or in multi media over the Internet.

In one aspect of the invention, advisory alerts are disseminated based on information received from conventional sources, such as government-based EAS broadcasts, commercial news organizations and wire services, law enforcement agency data, etc. In another aspect of the invention, event-related data can originate from “grass roots” sources so as to provide an on-line neighborhood crime watch system. To implement such a system, an individual subscriber would have a means to provide event reports to a central monitoring station (with human operators) to receive reports which would correlate the information and then disseminate the appropriate advisory alerts through a central notification computer. As described above, the advisory alerts are geographically specific and are sent only to subscribers in the relevant neighborhoods. The reports can include direct observations of criminal acts or suspicious activity, traffic accidents, sightings of apparently lost animals, etc.

An example of an advisory alert which may be sent is a “neighborhood crime watch” application of the invention. In this “neighborhood crime watch” arrangement, the system of the invention provides nearly instantaneous transmission of relevant event data to the affected parties since the event data does not have to filter through the conventional news dissemination entities. The method of the invention can thus provide a neighborhood-based communication network which links the members of the community to one another and rapidly disseminates information vital for the safety of the community.

Data sets are stored in a subscriber database. Each electronic device address A₁₋ₙ can be associated with a plurality of geographical locations B₁₋ₙ in the subscriber database. The end user device need not be physically located in the geographical locations B₁₋ₙ. A subscriber may wish to monitor events taking place in any number of geographic areas at once. For example, a subscriber address can be simultaneously associated with (1) the subscriber's home neighborhood, (2) the neighborhood of the subscriber's workplace, (3) the school attended by the subscriber's children, and (4) the neighborhood of a relative. In addition, it may be desired to provide temporary geographic associations an individual subscriber. In such a situation, a subscriber might be attending a large scale event (such as a concert, festival, or sports event) and would like to remain informed of any criminal activity or otherwise hazardous situation which may be taking place in the immediate area for the duration of the event. In this scenario, the address of the subscriber would be associated with the event location only for the duration of the event.

Advisory alerts transmitted in accordance with the method of the invention will necessarily range from high level alert situations (terrorist attacks, water supply contamination, evacuation orders, etc.) to relatively low level alert situations (automobile accidents, petty thefts). The advisory alerts can be graded, for example, on a numerical scale, to indicate the relative degree of danger to the recipient. In an alternative arrangement of the invention, a means is provided for a subscriber to select the lowest threshold level of advisory alert they wish to receive at a selected address. In this way, a subscriber can choose to receive higher alert advisories so that the subscriber is not inundated with low level alerts.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A method of broadcasting advisory alerts via communications networks to individual home pages, comprising:
providing a central notification computer in communication with at least one communications network;
maintaining a subscriber database of electronic device addresses to receive the advisory alerts, wherein the subscriber database includes a plurality of subscriber data sets, the data sets including the electronic device address of subscriber homepages and at least one geographic location associated with the subscriber;
maintaining the subscriber database in a computer retrievable format for access by the central notification computer;
providing a means to initiate an advisory alert broadcast from the central notification computer;
activating an algorithm to retrieve the electronic device addresses associated with a geographical location within the perimeter and said subscriber data sets;
transmitting the advisory alert to the subscriber homepage associated with geographic locations within the perimeter,
displaying the advisory alert in an image format on a customized user home page, wherein the personal preferences select the alerts to be monitored and format of the user's home page based upon the user's personal preferences.

2. The method of claim 1, wherein the communications network is a computer network, and the electronic device addresses are homepage website addresses.

3. The method of claim 1, wherein the advisory alert also includes a text format.

4. The method of claim 1, wherein the advisory alert further includes an audio format.

5. The method of claim 1, wherein the image format is a video clip.

6. The method of claim 1, wherein the perimeter of said geographic area is enlarged as function of time elapsed from the original notification.

7. The method of claim 1, wherein the advisory alert concerns a missing person.

8. The method of claim 1, wherein the advisory concerns a missing pet.

9. The method of claim 1, wherein the advisory alert is an announcement from an educational institution to notify parents of emergencies which might result in lock downs, evacuations or early dismissals.

10. The method of claim 1 wherein a user's customized home page is set up automatically when the user registers and enters the user's preferences on the network whereby the user can stay in touch with the people they care about and see only the news they want to see.

11. A method of broadcasting advisory alerts via communications networks comprising:
providing a central notification computer in communication with at least one communications network;
providing a means to transmit an advisory alert to a plurality of electronic device addresses from the central notification computer;
maintaining a subscriber database of electronic device addresses to receive the advisory alerts, wherein the subscriber database includes a plurality of subscriber data sets, the data sets including the electronic device address and at least one geographic location associated with the electronic device address;
maintaining the subscriber database in a computer retrievable format for access by the central notification computer;
providing a means to initiate an advisory alert broadcast from the central notification computer;
associating a geographic area with the advisory alert, wherein the geographic area is defined by a perimeter;
activating an algorithm to retrieve the electronic device addresses associated with geographical locations within the perimeter; and
transmitting the advisory alert to the electronic device address associated with geographic locations within the perimeter
providing a means to allow the user to register on the network and input their personal preferences,
displaying the advisory alert in an image format on a customized user home page, wherein the personal preferences select the alerts to be monitored and format of the user's home page, and,
providing an advertising module executable at the notification computer; wherein said advertising module is configured to select advertisement content from a database of advertisers located within the geographical location associated with the advisory alert, and further configured to provide the advertisement in conjunction with the advisory alert.
